(19) United States
(12) Patent Application Publication
(10) Pub. No.: US 2025/0319335 A1
(43) Pub. Date: Oct. 16, 2025

(54) ADJUSTMENT DEVICE OF A WIRE ELEMENT AND ROPING HARNESS PROVIDED WITH ONE SUCH ADJUSTMENT DEVICE

(71) Applicant: ZEDEL, Crolles (FR)

(72) Inventor: Simon EMONIN, Grenoble (FR)

(73) Assignee: ZEDEL, Crolles (FR)

(21) Appl. No.: 19/174,470

(22) Filed: Apr. 9, 2025

(30) Foreign Application Priority Data
Apr. 10, 2024 (FR) 2403703

(51) Int. Cl. A62B 35/00

(52) U.S. Cl. CPC A62B 35/0025

(57) ABSTRACT

An adjustment device of a length of wire element includes a wire element, a body and a clamping element installed able to move between a clamping position and a releasing position of the wire element. The body defines a first aperture and a second aperture designed for the wire element to pass through. The apertures are separated by a bearing wall. The clamping element is installed able to pivot with respect to the body around a pivot shaft to move towards or away from the bearing wall. The clamping element has a support wall moving towards or away from the bearing wall. The two strands passing through a second aperture are separated by the support wall and join one another passing round the pivot axis of the support wall formed by the body.

### BACKGROUND OF THE INVENTION

The invention relates to an adjustment device of a wire element and to a roping harness provided with one such adjustment device.

### PRIOR ART

To adjust the length of a webbing strap and in more general manner of a wire element, it is commonplace to use an adjustment buckle. Over the years, a large number of different configurations of adjustment buckles have been developed.

In conventional manner, the adjustment buckle has two rings of substantially rectangular shape that are installed on one another and are of different sizes. The smaller ring moves with respect to the larger ring to wedge the thicknesses of straps thereby achieving clamping of the chosen length.

This solution gives good results as regards keeping the chosen length, including when the tensile stresses applied on the strap increase. By moving the two rings with respect to one another, it is easy to slacken the buckle and modify the adjustment. However, it is observed that this configuration also results in a large decline of the mechanical performances of the strap.

Whereas the strap is measured to provide a first breaking strength value when it is used alone and stretched in its longitudinal direction, it is observed that addition of an adjustment buckle results in a division by two or three when the assembly is subjected to the same longitudinal force. Breaking occurs at much lower values and is not caused by breaking of the adjustment loop. To be able to withstand the expected stresses, the solution consists in replacing the strap by a thicker and/or broader strap.

This technical choice is not satisfactory as increasing the cross-section of the strap results in the general ergonomics being impaired.

Document US 2023/0065262 discloses a roping harness equipped with a connector designed to be attached on the one hand to a waistband and on the other hand to a leg loop by means of two length-adjustable straps. The connector defines two rings in addition to the two slots for the adjustable straps. The connector allows the attachment of a cam-lock device, enabling the length of a rope linking the right connector with the left connector to be adjusted. The cam locking device defines a hole for the passage of a strand of rope. The hole is delimited by a pivoting, spring-loaded cam to clamp the rope.

### OBJECT OF THE INVENTION

One object of the invention consists in providing an adjustment device that ensures that the chosen length is well preserved, and that procures an improved breaking strength in comparison with the configurations of the prior art using equivalent wire elements, while at the same time being simple to use and in particular easy to adjust.

This result tends to be achieved by means of an adjustment device configured to adjust a length of wire element comprising:
a wire element;
a body having at least a first wall, a bearing wall and a second wall arranged to define at least a first aperture and a second aperture designed for strands of the wire element to pass through, the first aperture being bounded at least by the first wall, the second aperture being bounded at least by the second wall, the second aperture being distinct from and separated from the first aperture by the bearing wall;
a clamping element installed movable between a clamping position and a releasing position, the clamping element being fixed to the body and installed movable pivoting with respect to the body around a pivot shaft to move towards or away from the bearing wall, the pivot shaft being located nearer to the first wall than to the second wall and nearer to the first wall than to the bearing wall in a first direction that passes successively via the first wall, the bearing wall and the second wall;
   wherein the clamping element has a support wall moving away from or towards the bearing wall;
   wherein a first strand of the wire element passes through the second aperture and extends along a first face of the support wall to pass round the first wall;
   wherein a second strand of the wire element passes through the second aperture and extends along a second face of the support wall and passes through the first aperture to pass round the first wall and be extended by the first strand:
   wherein in the clamping position, the first strand applies a force on the bearing wall in the direction of the support wall and the second strand is wedged between the support wall and the bearing wall; and
   wherein in the releasing position, the support wall defines a functional clearance with the bearing wall to allow the second strand to slide.

According to one feature of the invention, the second face of the support wall is provided with barbs designed to be inserted in the wire element.

In advantageous manner, the clamping element defines a through hole for the bearing wall to pass through, a height of the bearing wall being smaller than a height of the through hole in the direction of pivoting of the clamping element so as to impose pivoting of the clamping element within a predefined angular range.

In a particular configuration, the first direction of the body is curved.

In an advantageous development, a grip is mounted pivoting around a second pivot shaft extending parallel to the first pivot shaft.

Preferentially, the clamping element is mounted pivoting around the first wall.

According to one embodiment, the bearing wall does not present any sharp edges in a contact area with the wire element.

In an advantageous development, the clamping element does not present any sharp edges in a contact area with the wire element.

Preferentially, the bearing wall is of circular cross-section and/or the clamping element defines a circumvention zone by the wire element, the outer face of which zone is a portion of an arc of a circle.

In another advantageous development, the body is mounted pivotally with respect to a support around an additional pivot shaft.

In preferential manner, the second wall forms the additional pivot shaft.

It is advantageous to provide for the body to define a fastening ring distinct from the first aperture and the second aperture.

Preferentially, the clamping element is formed by an inner part and an outer part both mounted pivotally around the first wall, the outer part being mounted movable with respect to the inner part with a limited functional clearance, the inner part and outer part being separated by the bearing wall.

It is a further object of the invention to provide a roping harness that has an adjustable lanyard the length of which is well secured following a tensile loading, that presents a greater tensile strength than the configurations of the prior art for a predefined wire element and that remains easy to adjust.

Advantageously, the roping harness comprises an adjustment device of a wire element according to any one of the foregoing configurations wherein the support is a strap fixed to the belt or to one of the leg loops.

Preferentially, the wire element connects the belt with a connector connected to a movable anchor point.

Even more preferentially, the roping harness comprises a second adjustment device configured to adjust a length of a second wire element according to any one of the previous configurations wherein the adjustment device is attached to the abdominal belt on either a right or a left side with respect to a median sagittal plane and the second adjustment device is attached to the abdominal belt on the other of the right or left side, the second wire element connecting the belt to a second connector connected to the movable attachment point.

### BRIEF DESCRIPTION OF THE DRAWINGS

Other advantages and features will become more clearly apparent from the following description of particular embodiments and implementation modes of the invention given for non-restrictive example purposes only and represented in the appended drawings, in which:

FIG. 1 schematically illustrates a perspective view of a lanyard provided with a first embodiment of an adjustment device in a clamping position;

FIG. 2 schematically illustrates a sectional view of a lanyard provided with the first embodiment of an adjustment device in a clamping position;

FIG. 3 schematically illustrates a perspective view of a lanyard provided with a second embodiment of an adjustment device in a releasing position;

FIG. 4 schematically illustrates a sectional view of a lanyard provided with the second embodiment of an adjustment device in a releasing position;

FIG. 5 schematically illustrates a perspective view of a lanyard provided with the second embodiment of an adjustment device in a clamping position;

FIG. 6 schematically illustrates a sectional view of a lanyard provided with the second embodiment of an adjustment device in a clamping position;

FIG. 7 schematically illustrates a perspective view of a lanyard provided with a third embodiment of an adjustment device in a releasing position;

FIG. 8 schematically illustrates a sectional view of a lanyard provided with the third embodiment of an adjustment device in a releasing position;

FIG. 9 schematically illustrates a perspective view of a lanyard provided with the third embodiment of an adjustment device in a clamping position;

FIG. 10 schematically illustrates a sectional view of a lanyard provided with the third embodiment of an adjustment device in a clamping position;

FIG. 11 schematically illustrates a perspective view of a roping harness provided with two lanyards attached to a belt;

FIG. 12 schematically illustrates a perspective view of a body according to the first embodiment of the adjustment device;

FIG. 13 schematically illustrates a perspective view of a body according to the second embodiment of the adjustment device;

FIG. 14 schematically illustrates a perspective view of a clamping element;

FIG. 15 schematically illustrates another embodiment of an adjustment device;

FIG. 16 schematically illustrates an inner part of a clamping element;

FIG. 17 schematically illustrates a perspective view of the top of an outer part of a clamping element;

FIG. 18 schematically illustrates a perspective view of the bottom of an outer part of a clamping element;

FIG. 19 schematically illustrates a perspective view of an inner part of a clamping element installed on a body;

FIG. 20 schematically illustrates a perspective view of an inner part and an outer part of a clamping element installed on a body;

FIG. 21 schematically illustrates a sectional view of a clamping element provided with an outer part and an inner part mounted on a body.

### DESCRIPTION OF THE EMBODIMENTS

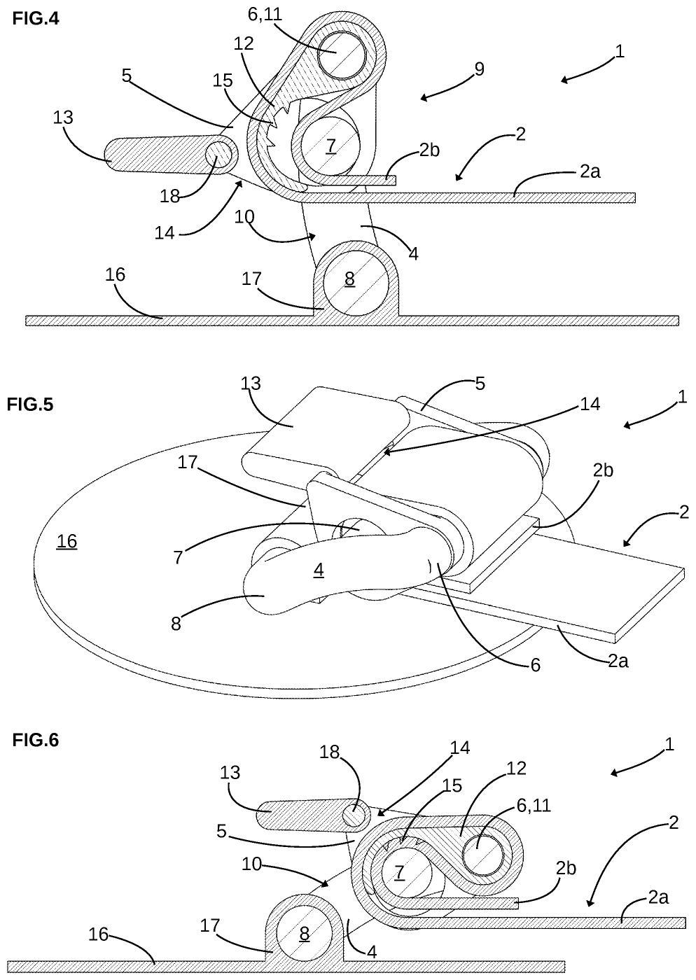

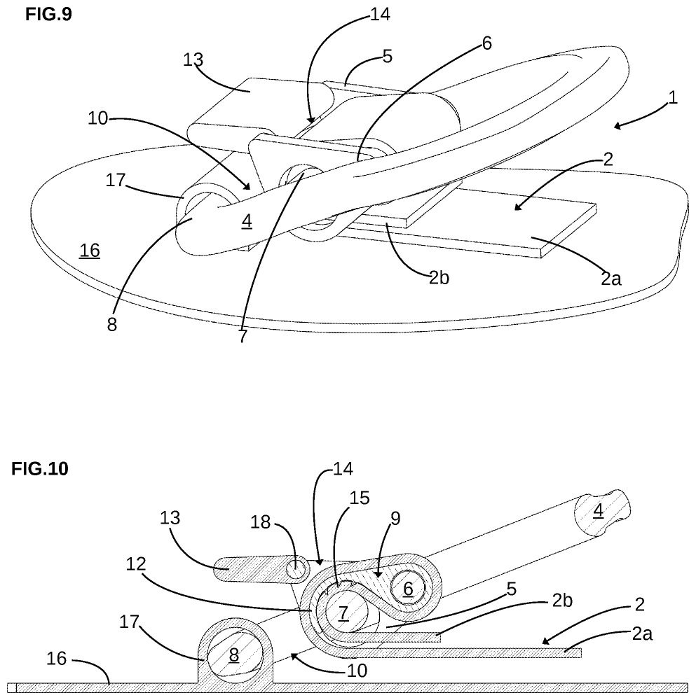

FIGS. 1 to 11 illustrate different embodiments of lanyards provided with an adjustment device 1 configured to adjust the length of a wire element 2 and a roping harness 3 provided with such lanyards with such an adjustment device 1.

The adjustment device 1 comprises a body 4 and a clamping element 5. The clamping element 5 is fixed to the body 4 and is installed movable with respect to the body 4.

The body 4 is an apertured element designed to be passed through by the wire element 2. The body 4 has at least a first wall 6, a bearing wall 7 and a second wall 8 to define at least a first aperture 9 and a second aperture 10 designed for the wire element 2 to pass through. The first aperture 9 is partly bounded by the first wall 6. The second aperture 10 is partly bounded by the second wall 8. The second aperture 10 is distinct from and separated from the first aperture 9 by the bearing wall 7.

FIGS. 12 and 13 illustrate two embodiments of a body 4. In the embodiment illustrated in FIG. 12, the body 4 bounds only the first aperture 9 and the second aperture 10. The body 4 is in the form of a ring the bearing wall whereof divides the central hole into the first aperture 9 and the second aperture 10. In the embodiment illustrated in FIG. 13, the body 4 defines an additional through hole in addition to the first aperture 9 and the second aperture 10. It is possible to have a body 4 that demarcates more apertures or through holes. The body 4 is preferably a non-deformable element, such as aluminum or steel. In other words, the bearing wall 7 is fixedly arranged relative to the first wall 6 and relative to the second wall 8.

In preferential manner, the first aperture 9 is bounded by the first wall 6 and by the bearing wall 7 and the second aperture 10 is bounded by the second wall 8 and the bearing wall 7 as illustrated in FIGS. 1 to 13. To enable the length of the wire element 2 to be adjusted easily, it is advantageous for the width and height of both the first aperture 9 and the second aperture 10 to be greater than the width and thickness of the wire element 2. The first aperture 9 and/or the second aperture 10 can have a rectangular cross-section when the wire element 2 is a strap or any other element having a width that is distinctly larger than its thickness.

The adjustment device has a clamping element 5 that is arranged movable between a clamping position and a releasing position. In the clamping position, the clamping element 5 clamps the wire element 2. In the releasing position, the clamping element 5 allows the wire element 2 to slide relative to the body 4. The clamping element 5 is installed able to pivot with respect to the body 4 around a pivot shaft 11 to move towards or away from the bearing wall 7. The pivot shaft 11 is located closer to the first wall 6 than to the second wall 8 and closer to the first wall 6 than to the bearing wall 7 in a first direction passing successively via the first wall 6, the bearing wall 7 and the second wall 8. A particular embodiment of the clamping element 5 is illustrated in FIG. 13.

The clamping element 5 has a support wall 12 and preferentially a grip 13. The grip 13 and the support wall 12 demarcate a passage hole 14 for the wire element 2 to pass through.

The wire element 2 is divided into a first strand 2a and a second strand 2b. The first strand 2a of the wire element 2 passes through the second aperture 10 and the passage hole 14. The first strand 2a extends to run along a first face of the support wall 12 and pass round the first wall 6. The second strand 2b of the wire element 2 passes through the second aperture 10 and runs along a second face of the support wall 12 passing round the bearing wall 7 to pass through the body 4 via the first aperture 9. As it continues to extend, the second strand 2b passes round the first wall 6 to form the first strand 2a. As illustrated, the wire element 2 forms a loop around the first wall 6.

In other words, the first strand 2a and the second strand 2b pass through the body 4 via the second aperture 10. The two strands extend in the direction of the first wall 6 to then pass round the first wall 6 and join up. The two strands are separated by the support wall 12. The second strand 2b passes through the body 4 again via the first aperture 9 and passes round the first wall 6 to join the first strand 2a. The second strand 2b is located between the bearing wall 7 and the support wall 12. The support wall 12 is located between the first strand 2a and the second strand 2b. When the second strand 2b is tensioned, the second strand 2b makes the support wall 12 pivot towards the bearing wall 7. As the second strand 2b is located between the support wall 12 and the bearing wall 7, the first strand 2a applies a force on the support wall 12 in the direction of the bearing wall 7 pressing the first strand 2a against the bearing wall 7, thereby clamping the wire element 2 in the chosen position against the bearing wall 7. The clamping element 5 is in the clamping position. The loop of wire element 2 passes through the body 4 via the second aperture 10 and passes round the bearing wall 7. The two strands follow different paths so that the loop surrounds the first wall 6 and the support wall 12 so that the second strand 2b can be trapped between the bearing wall 7 and the support wall 12 when the first strand 2a is pulled.

The greater the tensile force applied on the first strand 2a, the greater the force applied by the support wall 12 on the second strand 2b to keep the second strand 2b in position. The first strand 2a is the tensioned strand whereas the second strand 2b is the free strand.

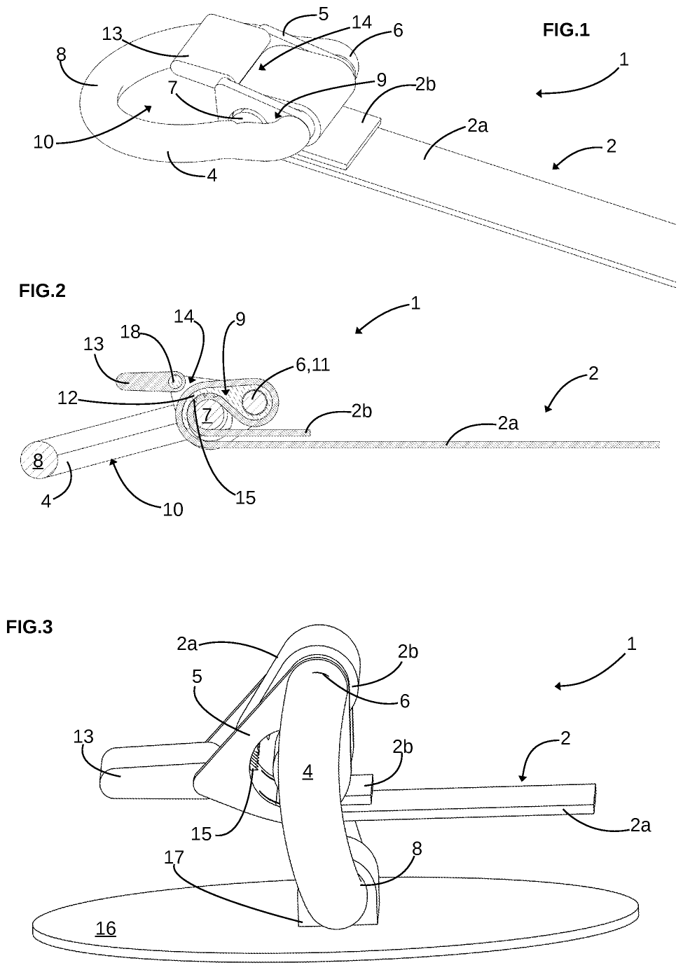

In the clamping position, the clamping element 5 presses the second strand 2b against the bearing wall 7 having the effect of clamping the second strand 2b. In the releasing position, the clamping element 5 defines a functional clearance with the bearing wall 7 to allow the second strand 2b to slide. In the clamping position, the force applied by the first strand 2a presses the first strand 2a against the support wall 12 and presses the support wall 12 against the second strand 2b. The wire element 2 is locked by friction and not by pinching as in prior art configurations. The support wall 12 prevents direct friction between the first strand 2a and the second strand 2b. As shown in FIGS. 2, 4, 6, 8, 10, 15 and 21, the curvature of the support wall 12 is close to or identical to the curvature of the bearing wall 7, so that there is as much support as possible between the wire element 2 and the bearing wall 7 and between the wire element 2 and the support wall 12. By matching the curvatures, pinching of the wire element 2 is avoided.

As shown in FIGS. 2, 4, 6, 8, 10, 15 and 21, the bearing wall 7 has no sharp edges to avoid reducing the breaking strength. The bearing wall 7 may have a circular or substantially circular cross-section. The support wall 12 can define a hook in the form of a circular arc.

In preferential manner, to keep the second strand 2b clamped, the support wall 12 can be provided with the barbs 15, teeth or any other means able to be inserted in the second strand 2b. the barbs 15 enable the second strand 2b to be kept in position even when the tension in the first strand 2a decreases. It is particularly advantageous for the barbs 15 to be arranged facing the circumvention zone of the bearing wall 7 by the second strand 2b as it is easier to achieve contacting between the barbs 15 and the second strand 2b that will tend to follow the shape of the bearing wall 7. Circumvention can take place over at least 180°, preferably at least 270°.

In the embodiments illustrated in FIGS. 1 to 11, the pivot shaft 11 that enables the clamping element 5 to pivot with respect to the body 4 also forms the first wall 6. In other words, the clamping element 5 is arranged pivotable with respect to the body 4 around the first wall 6. In this particular case, the first strand 2a and the second strand 2b pass round the first wall 6, that also forms the pivot shaft 11, to join one another.

In an alternative embodiment illustrated in FIG. 15, the body 4 defines more apertures than the first aperture 9 and the second aperture 10. The pivot shaft 11 is not formed by the first wall 6. The clamping element 5 defines an additional aperture so that the wire element 2 passes through the support wall 12 and enables the first strand 2a to be continued by the second strand 2b. Operation of the clamping element 5 is identical to that described in the foregoing with the first strand 2a that is designed to press the support wall 12 against the second strand 2b and against the bearing wall 7 to fix the position of the second strand 2b.

To make it easier to actuate the clamping element 5 to the releasing position, it is advantageous to provide for the clamping element 5 to be provided with a grip 13. In the illustrated embodiments, the grip 13 is installed facing the support wall 12 and the bearing wall 7 when the clamping device 5 is in the clamping position. The installation in facing manner defines the passage hole 14.

Another configuration of the grip 13 is possible, for example by locating the latter in offset manner with respect to the support wall 12 in a parallel direction to the pivot axis of the clamping element 5.

Fixing of the clamping element 5 on the body 4 and assembly of the latter movably with respect to the body 4 are particularly advantageous as they ensure that the position of the second strand 2b is preserved, including when the body 4 moves.

In the embodiments illustrated in FIGS. 3 to 11, the body 4 is mounted movable with respect to a support 16. In preferential manner, the body 4 is mounted pivotable with respect to the support 16. In even more preferential manner, the body 4 is mounted pivoting around an additional pivot shaft that is formed by the second wall 8 or another wall.

The support 16 defines a through cavity 17 and the second wall 8 passes via the through cavity 17. Preferentially, the additional pivot axis of the body 4 with respect to the support 16 mainly comprises a component parallel to the pivot axis of the clamping element 5 with respect to the body 4.

Tensioning of the first strand 2a results in the body 4 moving to the side having the clamping element 5. When the body 4 is led to move in the opposite direction with respect to the support 16, the body 4 and the clamping element 5 move in a direction that tends to increase the tensile stress in the first strand 2a so that the second strand 2b remains clamped against the bearing wall 7. The same is the case when the body 4 moves in the direction of the end of the first strand 2a that is not fixed to the body 4. This movement can lead to a reduction of the stress in the first strand 2a. It may be advantageous to use the barbs 15 to ensure a good attachment.

Due to its construction with two apertures separated by the bearing wall 7, the body 4 is able to perform clamping of the wire element 2 that winds around the bearing wall 7, the two strands thereof joining one another around the first wall 6. However, once the wire element 2 has been clamped and tensioned, it is very difficult or even impossible to move the wire element 2 inside the body 4. It is then particularly advantageous to use the clamping element 5 installed movably with respect to the body 4. By moving the clamping element 5 away from the bearing wall 7 with respect to the body 4, the value of the force applied by the support wall 12 on the second strand 2b can be reduced. Reducing the value of the force allows the first strand 2a and the second strand 2b to slide.

A body defining two apertures for a strap to pass through and performing the function of clamping the strap is known to slackline users under the “Banana” trade name. The “Banana” device is used to clamp a strap at the required length. The “Banana” device is used in association with an adjustment device, for example a ratchet tensor that stretches the strap and then relaxes the strap at the end of use. However, in this practice, it is not sought to be able to perform adjustment of the length of the tensioned strap easily. The “Banana” device does not enable the length of strap that is tensioned to be adjusted.

When the support wall 12 is provided with the barbs, sliding of the second strand 2b is possible when the support wall 12 reaches a threshold position corresponding substantially to the position where the barbs 15 are no longer inserted in the wire element 2.

For ease of movement of the clamping element 5 from the clamping position to the releasing position, it is advantageous for the adjustment device to be provided with a grip 13, and more particularly for the grip 13 to be fixed to the clamping element 5 and to be mounted pivoting with respect to the clamping element 5 so that the position of the grip 13 better matches the direction of the force to be applied to move the support wall 12 away from the bearing wall 7.

It is particularly advantageous to provide for the bearing wall 7 not to have any sharp edges to avoid shearing the wire element 2 when the latter is subjected to high stresses. More preferentially, the contact surface with the wire element 2 is curved and the bearing wall 7 advantageously presents a circular cross-section.

It is also advantageous for the contact area between the wire element 2 and the first wall 6 not to present any sharp edges. It is advantageous for the first wall 6 to present a curved surface and preferentially a circular cross-section. However, if the wire element 2 is only in contact with the clamping element 5 and not with the first wall 6 as illustrated in FIGS. 2 to 11, the cross-section of the first wall 6 is of little importance. It is then advantageous for the part of the clamping element 5 designed to be covered by the wire element 2 to be a curved surface and more preferentially an arc of a circle.

FIGS. 1 and 2 illustrate an embodiment of an adjustable-length lanyard. The lanyard has a wire element 2 and a body 4 that defines a fastening ring designed for attaching a connector. As indicated in the above, the orientation of the body 4 with respect to the longitudinal axis of the first strand 2a does not have any effect on clamping of the second strand 2b so long as the clamping element 5 is in the clamping position. The grip 13 can be installed pivoting around a grip shaft 18 that is fixed to the clamping element 5. The grip shaft 18 is mounted stationary with respect to the clamping element 5.

Movement of the clamping element 5 with respect to the body 4 is made easier thereby making the effective length of the wire element 2 easier to lengthen when the first strand 2a is tensioned.

FIGS. 3 to 11 illustrate embodiments where the body 4 is mounted pivoting with respect to a support 16. FIGS. 3, 4, 7 and 8 illustrate two different embodiments of a body 4 with the clamping element 5 in a releasing position. FIGS. 5, 6, 9 and 10 illustrate two different embodiments of a body 4 with the clamping element 5 in a clamping position.

FIGS. 3 to 6 illustrate an embodiment in which the body 4 is curved, i.e. the direction that successively connects the first wall 6, the bearing wall 7 and the second wall 8 is curved.

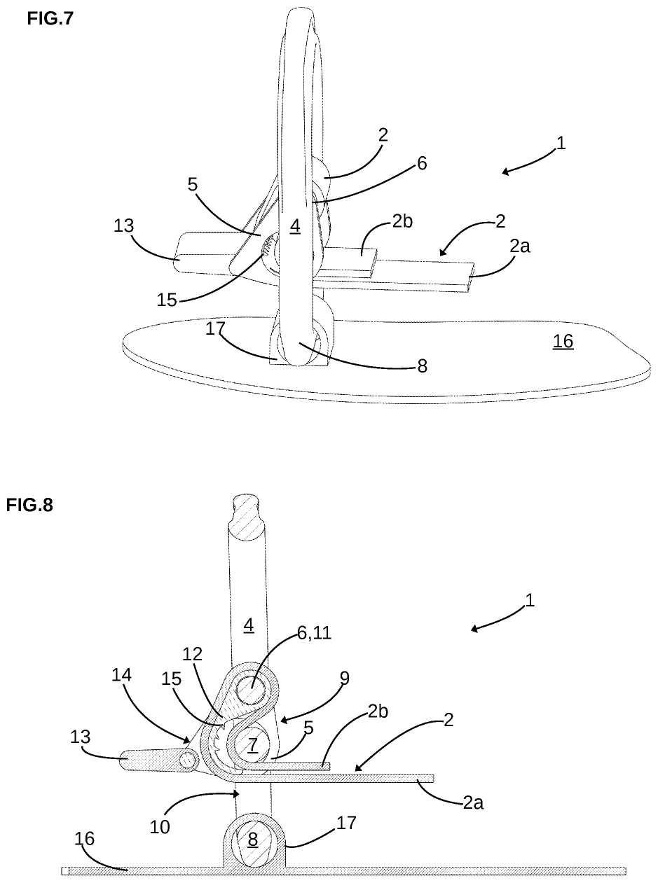

FIGS. 7 to 10 illustrate an embodiment in which the body 4 is flat, i.e. the direction that successively connects the first wall 6, the bearing wall 7 and the second wall 8 is a straight line.

In a particular embodiment, the clamping element 5 is installed movable with respect to the body 4 within a limited angular range, for example an angular range of less than 20°. The clamping element 5 defines a through hole and the bearing wall 7 passes through the through hole. The dimension of the through hole is larger than the dimension of the bearing wall 7 to allow a relative movement between the clamping element 5 and the bearing wall 7. The difference between the dimension of the bearing wall 7 and the wall defining the through hole limits movement of the clamping element 5 with respect to the bearing wall 7. Limiting the angular amplitude of the clamping element 5 ensures that the clamping element 5 will clamp the second strand 2b following a tensile force applied on the first strand 2a.

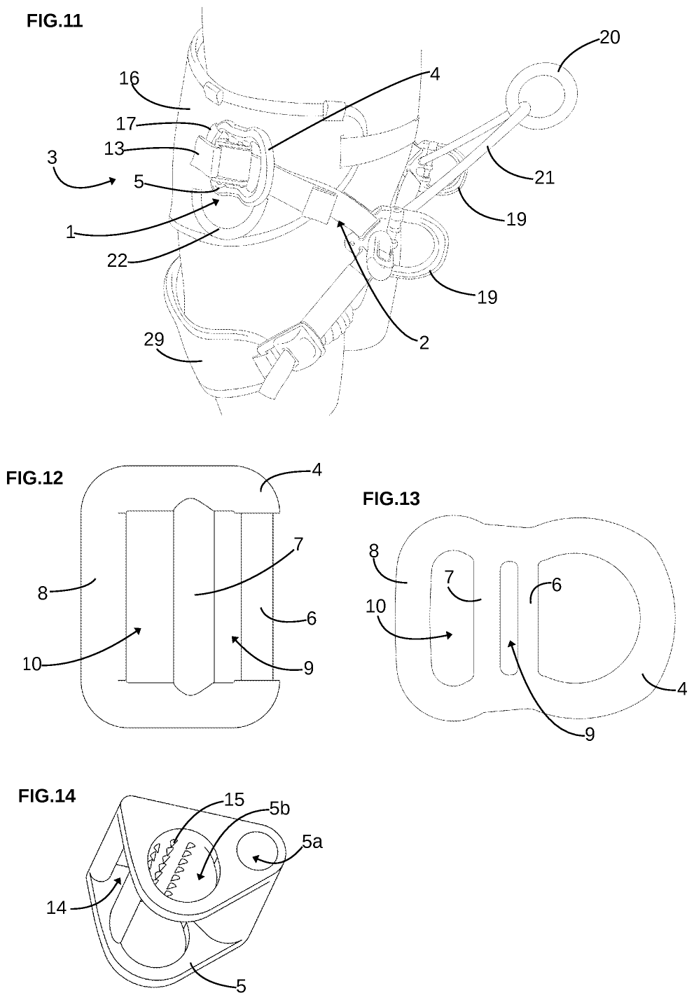

FIG. 11 illustrates a roping harness 3 provided with a belt forming the support 16 and with a pair of leg loops 29. The lanyard is fixed to the belt by means of the body 4 that is fixed to a through cavity 17.

In a particular embodiment illustrated in FIG. 11, the lanyard has a connector 19 at one end of the first strand 2a. The lanyard provided with the connector 19 is fixed to the belt, and the connector 19 attached to an anchor point is able to support a user suspended in the roping harness 3.

In preferential manner, the connector 19 is fixed irremovably to the first strand 2a. The adjustment device 1 is configured to move the connector 19 towards or away from the belt.

In an advantageous embodiment, the connector 19 is also fixed to a leg loop 29 so that the forces related to the weight of the user suspended in the harness are shared between the belt and the leg loops 29.

Preferentially, the roping harness 3 is provided with two lanyards, one of which is attached to the right part of the belt and the other of which is attached to the left part of the belt. The left and right parts are separated by the median sagittal plane of the user who is wearing the roping harness 3.

More advantageously, the two connectors 19 form a right connector and a left connector that are respectively attached to the right leg loop and the right part of the belt or to the left leg loop and the left part of the belt. It is then advantageous to attach a movable anchor point 20 to the two connectors 19 and more preferentially to attach a flexible link 21 to the two connectors and to move the movable anchor point 20 along the flexible link 21, for example by sliding along the flexible link 21. The flexible link 21 can be a rope or a strap. The movable anchor point 20 can be a ring.

The belt can also be provided with a gear sling 22 and any other equipment necessary for good practice by the user. The wire element 2 is preferentially a strap or any other element having a larger length than its width, the latter being larger than the thickness.

FIG. 14 illustrates an embodiment of a clamping element 5. The clamping element 5 defines a first through hole 5a for the first wall 6 to pass to form the pivot shaft 11. The clamping element 5 defines a second through hole 5b for the bearing wall 7 to pass through so as to limit the angular movement allowed for pivoting of the clamping element 5 with respect to the body 4. The first through hole 5a and the second through hole 5b are preferentially dissociated from one another.

It is advantageous for the clamping element 5 to define a portion with a complementary shape to the shape of the bearing wall 7 in order to have a strong contact between the second strand 2b and the clamping element 5, thereby making it easier to keep the clamping intact when the tensile stress in the first strand 2a decreases. In the illustrated embodiment, the clamping element 5 is devoid of the grip 13.

FIG. 15 illustrates an alternative embodiment wherein the wire element 2 does not pass round the pivot shaft 11. The body 4 defines one or more additional apertures in addition to the first aperture 9 and the second aperture 10. The clamping element 5 defines a through opening at the end of the support wall 12 to allow the first strand 2a to pass from the first face of the support wall 12 in the direction of the other face of the body 4 to pass round the first wall 6 and form the second strand 2b. As for the previous embodiments, the tensile effort applied on the first strand 2a presses the support wall 12 against the bearing wall 7 thereby wedging the second strand 2b.

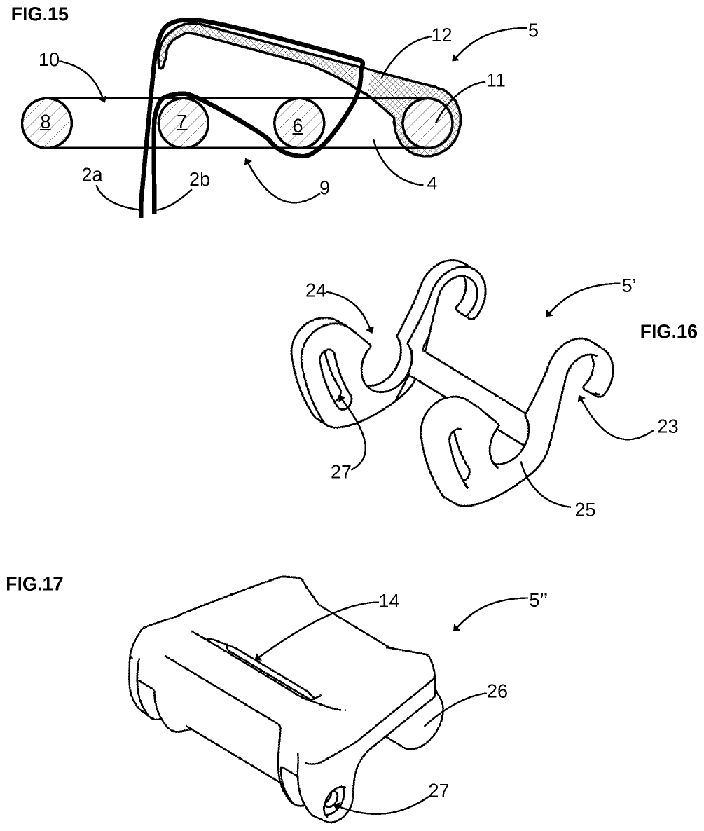

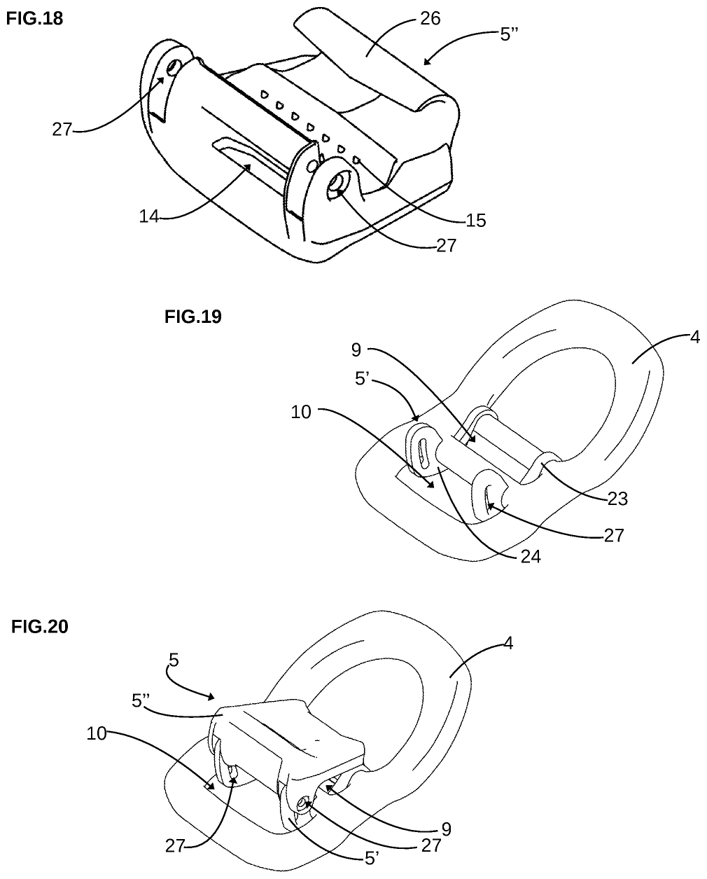

In FIGS. 1 to 15, the clamping element 5 is present in the form of a monolithic part. However, it is also possible to form the clamping element 5 in several parts, for example with an inner part 5′ and an outer part 5″. The inner part 5′ is illustrated in FIG. 16 whereas the outer part 5″ is illustrated in FIGS. 17 and 18 respectively in top view and in bottom view.

The inner part 5′ can define one or more first hooks 23 that are designed to latch onto the first wall 6 and enable pivoting with respect to the first wall 6. The first hooks 23 work in the same way as the wall that bounds the first through hole 5a. The inner part 5′ also defines one or more second hooks 24 that are designed to receive the bearing wall 7. The inner part 5′ is apertured to allow the wire element 2 to pass. The inner part 5′ can be provided with arms 25 connecting the first hooks 23 and the second hooks 24.

The outer part 5″ defines one or more hooks 26 that are designed to receive the bearing wall 7. The outer part 5″ defines the barbs 15.

The inner part 5′ is arranged movable with respect to the outer part 5″. The inner part 5′ and the outer part 5″ are arranged in movable manner pivoting independently around the first wall 6.

The space between the inner part 5′ and the outer part 5″ defines the passage hole 14. Preferentially, the passage hole is extended by at least one through hole that passes through top part 5″ as illustrated in FIGS. 17 and 18.

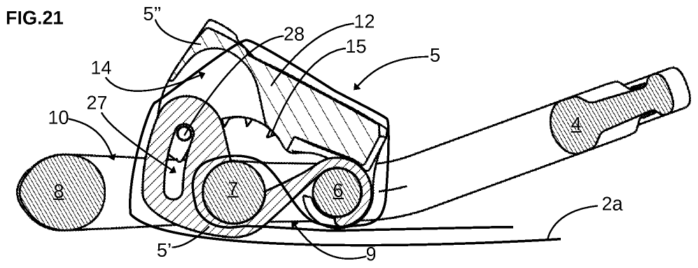

It is particularly advantageous for the inner part 5′ to be movable with respect to the outer part 5″ with a limited functional clearance. In the illustrated embodiment, the inner part 5′ and the outer part 5″ both define apertures 27 that are facing one another. A rod 28 passes through the two apertures 27 to limit the movements of the outer part 5″ with respect to the inner part 5′. As illustrated in FIGS. 20 and 21, the inner part 5′ and the outer part 5″ are separated by the bearing wall 7. The outer part 5″ forms the support wall 12.

In the embodiment illustrated in FIG. 21, the inner part 5′ and the outer part 5″ are attached to a body 4. The body 4 is designed to be fixed to a support 16.

The first strand 2a passes underneath the first wall 6 and the bearing wall 7 passing through the second aperture 10. The second strand 2b passes through the passage hole 14 and passes above the outer part 5″. The first strand 2a is extended by the second strand 2b that passes round the first wall 6 passing between the first wall 6 and the first strand 2a. The second strand 2b passes round the bearing wall 7. The second strand 2b is located between the bearing wall 7 and the outer part 5″. The second strand 2b escapes from the clamping element 5 passing between the first strand and the other portion of the second strand.

Tensioning of the first strand 2a and the second strand 2b has the effect of moving the outer part 5″ in the direction of the bearing wall 7 and of pressing the outer part 5″ against the second strand 2b. The second strand 2b is wedged against the bearing wall 7 and the outer part 5″. The first strand 2a presses the two portions of the second strand 2b against the inner part 5′ and/or against the first wall 6. When the strands are tensioned, application of a force on the outer part 5″ to move away from the inner part 5′ and away from the bearing wall 7 enables the pressing forces on the second strand 2b to be reduced, resulting in the strands being able to move more easily thereby making it easier to slacken the wire element.

1. An adjustment device configured to adjust a length of a wire element comprising:
a body having at least a first wall, a bearing wall and a second wall arranged to define at least a first aperture and a second aperture, the first aperture being bounded at least by the first wall, the second aperture being bounded at least by the second wall, the second aperture being distinct from and separated from the first aperture by the bearing wall;
a wire element having a first strand extended by a second strand;
a clamping element installed movable between a clamping position and a releasing position, the releasing position allowing sliding of the wire element with respect to the body and the clamping position clamping the wire element against the body, the clamping element being attached to the body and mounted pivoting with respect to the body around a pivot shaft to move towards or away from the bearing wall, the pivot shaft being located nearer to the first wall than to the second wall and nearer to the first wall than to the bearing wall, the first wall, the bearing wall and the second wall being disposed successively in a first direction;
wherein, in the clamping position, a support wall of the clamping element presses on the second strand to clamp the second strand against the bearing wall;
wherein the wire element passes round the first wall to define the first strand and the second strand;
wherein the first strand passes through the second aperture and extends to the first wall passing along a first face of the support wall;
in that the second strand passes through the second aperture and extends to the first wall to join the first strand passing along a second face of the support wall, so that the support wall is arranged between the first strand and the second strand;
wherein the second strand passes through the body between the bearing wall and the first wall;
wherein, when a tensile force is applied to the first strand, the first strand presses against the first face of the support wall to place the clamping element in the blocking position, the support wall pressing against the second strand to block the second strand against the bearing wall;
wherein, in the releasing position, the support wall defines a functional clearance with the bearing wall to allow sliding of the second strand.

2. The adjustment device of a wire element according to claim 1 wherein the second face of the support wall is provided with barbs designed to be inserted in the wire element.

3. The adjustment device of a wire element according to claim 1 wherein the clamping element defines a through hole for the bearing wall to pass through, a height of the bearing wall being smaller than a height of the through hole in the direction of pivoting of the clamping element so as to impose pivoting of the clamping element within a predefined angular range.

4. The adjustment device of a wire element according to claim 1 wherein the first direction of the body is curved.

5. The adjustment device of a wire element according to claim 1 wherein a grip is mounted pivoting around of a grip shaft extending in parallel manner to the pivot shaft.

6. The adjustment device of a wire element according to claim 1 wherein the clamping element is mounted pivoting around the first wall.

7. The adjustment device of a wire element according to claim 1 wherein the bearing wall does not present any sharp edges in a contact area with the wire element.

8. The adjustment device of a wire element according to claim 1 wherein the clamping element does not present any sharp edges in a contact area with the wire element.

9. The adjustment device of a wire element according to claim 7 wherein the bearing wall is of circular cross-section and/or the clamping element defines a circumvention zone to be circumvented by the wire element, an outer face of the circumvention zone is a portion of an arc of a circle.

10. The adjustment device of a wire element according to claim 1 wherein the clamping element is formed by an inner part and an outer part both mounted pivotally around the first wall, the outer part being mounted movable with respect to the inner part with a limited functional clearance, the inner part and outer part being separated by the bearing wall.

11. The adjustment device of a wire element according to claim 1 wherein the body is mounted pivotally with respect to a support around an additional pivot shaft.

12. The adjustment device of a wire element according to claim 11 wherein the second wall forms the additional pivot shaft.

13. The adjustment device of a wire element according to claim 11 wherein the body defines a fastening ring distinct from the first aperture and the second aperture.

14. A roping harness comprising an adjustment device configured to adjust a length of a wire element according to claim 11 wherein the support is a strap attached to the belt or to one of the leg loops.

15. The roping harness according to claim 14 wherein the wire element connects the belt with a connector connected to a movable anchor point.

16. The roping harness according to claim 15 comprising a second adjustment device configured to adjust a length of a second wire element, wherein the clamping element is formed by an inner part and an outer part both mounted pivotally around the first wall, the outer part being mounted movable with respect to the inner part with a limited functional clearance, the inner part and outer part being separated by the bearing wall, and wherein the adjustment device is attached to the abdominal belt on either a left or a right side with respect to a median sagittal plane and the second adjustment device is attached to the belt on the other of the left or right side, the second wire element connecting the belt to a second connector connected to the movable anchor point.
